(19) United States
(12) Patent Application Publication
(10) Pub. No.: US 2012/0221498 A1
(43) Pub. Date: Aug. 30, 2012

(54) AGGREGATING AND NORMALIZING ENTERTAINMENT MEDIA

(75) Inventors: Marcin Kaszynski, Warsaw (PL); Ryszard Szopa, Palo Alto, CA (US); Grzegorz Kapkowski, Grodzisk Mazowiecki (PL); Remigiusz Dymecki, Wroclaw (PL); Maciej Pasternacki, Resko (PL); Eran Dror, Brooklyn, NY (US)

(73) Assignee: SETJAM, INC., New York, NY (US)

(21) Appl. No.: 13/397,704

(22) Filed: Feb. 16, 2012

Related U.S. Application Data
(60) Provisional application No. 61/444,721, filed on Feb. 19, 2011.

(51) Int. Cl. G06F 17/30; G06F 15/16; G06F 15/18

(52) U.S. Cl. 706/12; 707/736; 707/737; 707/740; 709/203; 707/E17.046

(57) ABSTRACT

Disclosed are methods for making disparate entertainment media content (e.g., television or movies) from multiple sources available through a single interface of a user device. Content of varying data formats from multiple data sources are aggregated. Classifications of the media data are created which can include assigning content into clusters. The data are normalized, and attributes of the data are curated. Features also are provided to automatically synchronize, obtain, and update media content on the media sources and on client devices. Various ways of handling data aggregation and normalization issues associated with compiling media data also are described.

### CROSS-REFERENCE TO RELATED APPLICATIONS

The present application claims priority to U.S. Provisional Patent Application 61/444,721, filed on Feb. 19, 2011, which is incorporated herein by reference in its entirety.

### FIELD OF THE INVENTION

The present invention is related generally to entertainment metadata and, more particularly, to mapping disparate entertainment metadata datasets to a single identification for top-level elements (e.g. shows, episodes, movies, literature, and music).

### BACKGROUND OF THE INVENTION

Entertainment media sources for television shows and movies have multiplied and fragmented. Consumers must navigate content options from live television, digital video recorders, video on demand (“VOD”), Multichannel Video Program Distributor (“MVPD”) operated VOD-online sites, network-operated authenticated “TV Everywhere” sites, over-the-top (“OTT”) subscriptions, and OTT VOD retailers.

Playback devices have also multiplied and fragmented: MVPD settop boxes, OTT settop boxes, connected TVs, connected Blu-Ray players, personal computers, laptops, tablets, mobile phones, planes, trains, and automobiles. This further exacerbates the multiple-source issues, as each device has specific playback rights that must be managed for each entertainment media source. For example, Hulu™ prohibits manufacturers from showing their content on devices that connect to a TV but allows the content to be viewed on PCs and laptops.

In addition, new technologies such as search engines, recommendation engines, social media, and analytics packages are being integrated into the traditional TV infrastructure. Each of these is a separate source of metadata that should be mapped to a single identity for top-level entertainment elements (e.g., shows, episodes, movies, literature, and music).

### BRIEF SUMMARY

The above considerations, and others, are addressed by the present invention, which can be understood by referring to the specification, drawings, and claims. According to aspects of the present invention, data for entertainment media sources such as TV and movies are normalized. Data are abstracted from data sources using agents. Each agent contains intelligence to deal with the specific characteristics of its source, but in some embodiments most of the core functionality is normalized across the agents or is abstracted in processing layers.

According to aspects of the present invention, a system takes disparate datasets and maps them to a single ID algorithmically.

According to aspects of the present invention, manual curation of the entertainment media data is supported by a drag-and-drop web interface, and the manual feedback is subsequently incorporated into a core clustering algorithms.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a chart illustrating a logical flow of entertainment metadata from disparate sources, through algorithmic normalization processes and manual normalization processes, and finally delivered in a unified, machine-readable feed;

FIG. 2 is a schematic diagram of a computer network embodiment that enables normalization of entertainment metadata using algorithmic and manual processes;

FIG. 3 is a schematic diagram showing data flowing through a production cluster within a network embodiment; and

FIGS. 4 through 7 are screen shots from an exemplary user interface that editors use for manual normalization.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

The presence of multiple data sources as described above poses problems for consumers. A first problem is that each content source and each playback device may have its own searches, recommendations, and favorites. Thus a consumer may need to go from source to source to discover what is available on any single device and to manage multiple favorites lists. Then the consumer misses out on the benefits of recommendations because no single source or device has a complete picture of the consumer's viewing habits. The consumer may like to see (and, where possible, to control) viewing options across all of the devices from a guide on any one device.

Device manufacturers face the problem that there is no canonical list of television or movie data. Different sources classify shows in completely different ways, which can make compiling a unified list of shows and episodes across multiple sources extremely difficult. In addition, television and movie data are in a constant state of flux. New episodes air every day, and the list of shows available from a given source changes frequently and often unpredictably.

This leads to a dataset that is uniquely resistant to orderly classification. The particular aspects posing difficulties in such an endeavor include conflicting data, missing data, ambiguous data, TV vs. Web content, and timing.

Conflicting data are common because sources treat data about the same show quite differently. Episodes often have conflicting titles on different sources, often based on different method of abbreviation. Sources often have completely different metadata for the same episode because the same episode originally aired in different years for different providers.

In many cases, data are missing from the source's own feeds. Furthermore, sources may omit metadata even for specific records that they typically have.

In addition, many data elements are subject to interpretation which leads to ambiguities. For instance, multi-part episodes are often grouped in a number of different ways. Sometimes, relationships between various seasons are ambiguous.

Additional material or “bonus content” is frequently delivered in the feeds right alongside the episodes. Separating what content represents actual episodes of a show from which content represents additional material presents unique challenges in TV versus Web content. Sometimes, a Web series has the exact same naming scheme as a TV series. Also, sometimes one source considers special episodes to be part of a television series while another source considers them to be bonus material.

Finally, timing proves to be a chief difficulty in classifying TV and video media. Compiling a real-time list of available episodes involves fetching data from multiple sources at irregular and often unpredictable intervals. Most major sources update which shows are available every few hours, changing which links are active and which ones are dead. The period of time between a show airing on television, appearing on a particular source's website, and the link to the show appearing in that source's data feed are wildly inconsistent and vary between sources. Providing up-to-date data requires predicting these changes, which requires constant monitoring of these sources.

To address these and other problems, aspects of the present invention compile and classify data from several different sources across the Internet and other entertainment metadata sources and create singular identifications for entertainment data. Aspects of the present invention gather highly unstructured, inconsistent, and incomplete information from several different sources and return data that are fully structured, consistent, and complete.

Media content can include data representing literary, lyrical, or viewable content. In a preferred embodiment, media content refers to data representing television or videographic content, such as recorded television data, DVD data, digital picture data, and the like. Media content also refers to metadata associated with such content.

A “playback device” is a device for storing, playing, displaying, processing, or consuming any information affiliated with media content data. Examples of playback devices include laptop computers, notebook computers, tablet PCs, MP3 players, portable digital-video playing devices, portable digital-audio playing devices, digital cameras, TVs, Blu-Ray players, set-top boxes, and the like.

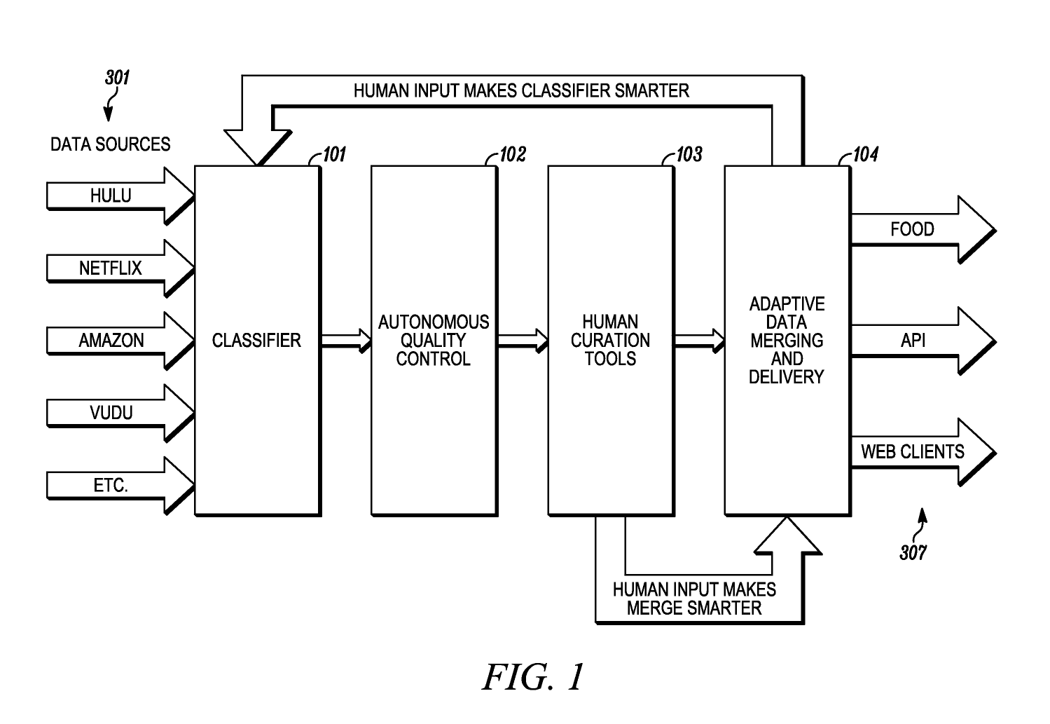

Aspects of the present invention are described with reference to the accompanying drawings, beginning with FIG. 1. FIG. 1 shows an exemplary system for mapping Internet TV, movies, and other sources of metadata to a single identification and for rendering a unified TV and movie data feed for end users. The first step is collecting entertainment metadata from at least one source 301 in their original format, which sources can include any known commercial metadata sources. Next is a classification process 101 that breaks the entertainment metadata into their constituent elements (e.g., images, descriptions, air-date, links, etc.) and maps those constituent elements to a singe ID using a clustering method (as opposed to a classifying method). The mapping process can include autonomous quality control 102.

Some embodiments provide a graphical display of the constituent metadata elements from various sources in, for example, a grid-like format. The graphical display allows a human to use curation tools 103 to drag elements from a source into a proper category as defined by other sources. This manual curation ability allows humans to set trust values for entertainment metadata elements from individual metadata sources by an algorithmic process. This manual curation ability is described in more detail below. The process of FIG. 1 can adaptively merge algorithmic and manually curated data into a single dataset 104. Human input enhances the process of merging the data because an algorithmic process recognizes patterns from the implicit actions of the manual processes. The algorithmic processes also learn better pattern recognition from the explicit actions of the manual processes. The process of FIG. 1 delivers the mapped, normalized media metadata to a single identification and renders a unified TV and movie data feed for end users.

Aggregating content of disparate data formats across various data sources may be carried out by retrieving the content from memory locally, by downloading the content from a network location, or by any other way of retrieving content that will occur to those of skill in the art.

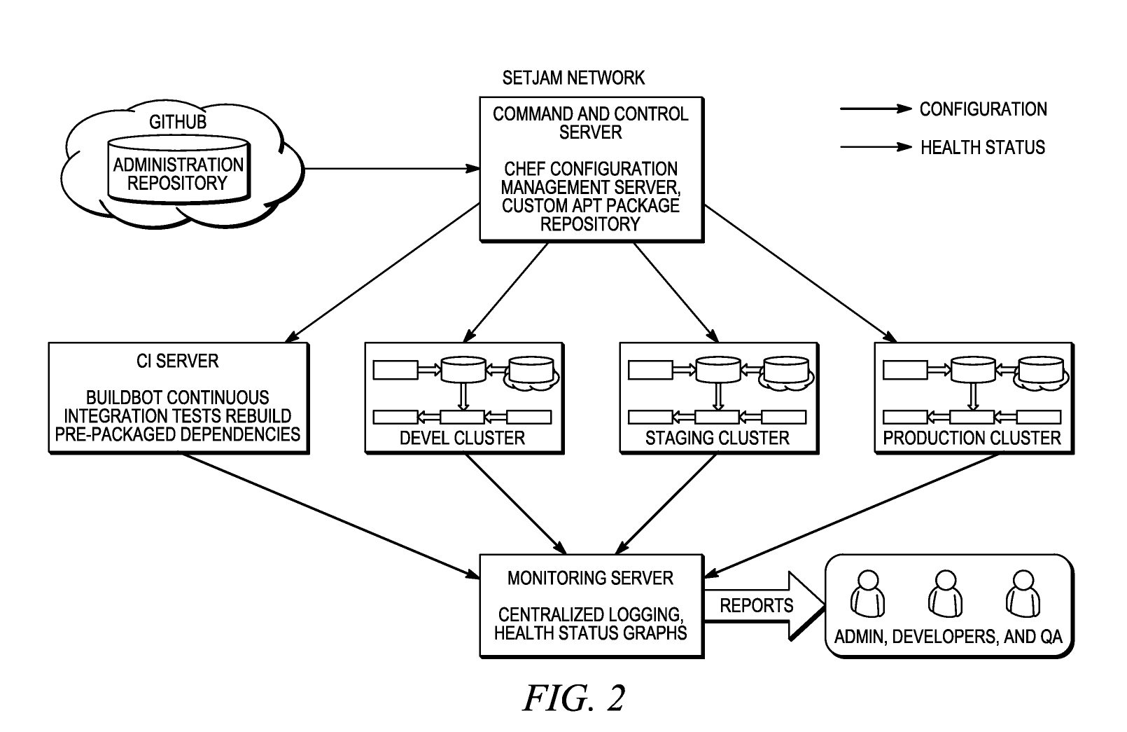

FIG. 2 depicts a computer network embodiment that normalizes entertainment metadata using algorithmic and manual processes. The system of FIG. 2 includes servers that render the entertainment metadata. In another embodiment, such entertainment metadata may be rendered as audio by playing the audio portion of the media content or by displaying text, video, and any images associated with the media data on a display screen of a media device.

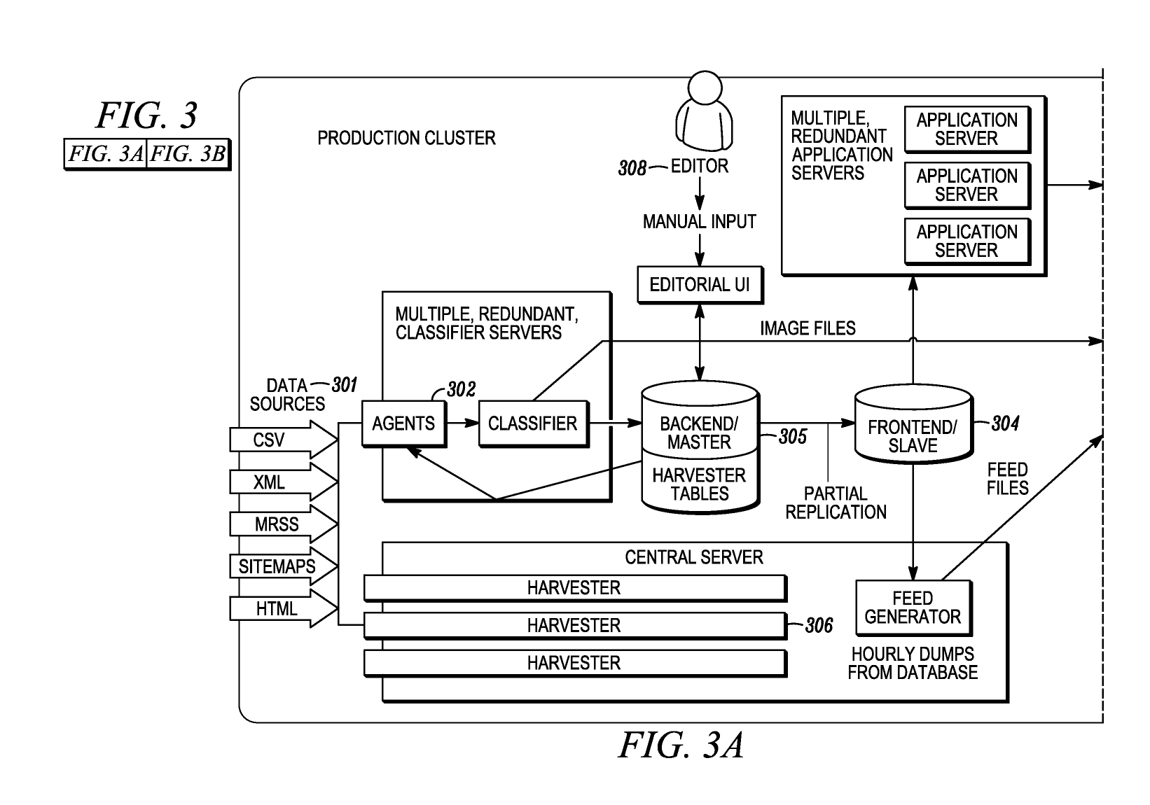

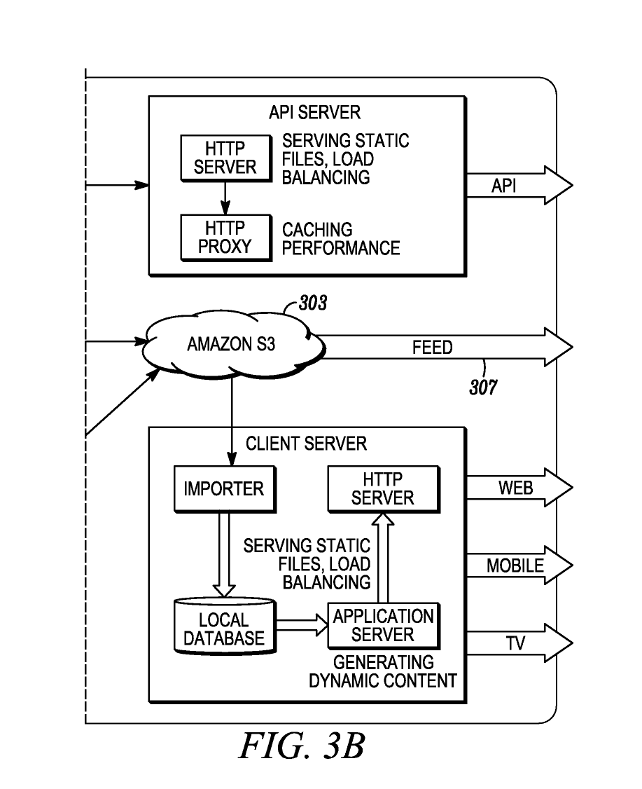

FIG. 3 shows the flow of data through a production cluster within a network embodiment. The first problem faced when collecting data from different sources 301 is that the data formats are not consistent. Second, many of the sources 301 describe the same show in slightly different ways.

In order to access the sources 301 in a uniform manner, the sources 301 are wrapped with an abstraction layer, represented in FIG. 3 by the agents 302. An agent 302 can be implemented as a Python callable that returns an iterable of Python dict, a core Python dictionary class. From the point of view of the rest of the system, agents 302 are black boxes: Arguments are provided identifying a show (the basics are the title, release year, whether it is a movie or a series), and the agent 302 returns dictionaries conforming to a specific format and containing metadata identifying the agent 302. The agent 302 is responsible for finding the right data in case the source 301 stores information about a show under a different title.

With a high quantity of entertainment media (TV shows and movies), it is a significant challenge to keep up with all the new episodes and Internet links that appear on-line daily. Furthermore, the whole process should be timely, taking less than 12 hours. According to the embodiment shown in FIG. 3, the solution is to divide the labor between multiple machines and process many titles in parallel, using Amazon SQS 303 as a means of work distribution. When the fetch process begins, the list of all titles (and other information relevant for agents such as release years, directors, languages, etc.) is sent to a queue.

Workers are normal Python programs that take a package from the queue, collect all necessary information from the agents 302, process it, and store the results. Then another package is taken from the queue. By increasing the number of machines involved, the fetch process can be accelerated in an almost linear fashion. Workers do not need to share any information with each other. This allows the process be done completely independently, on separate machines, without the need of blocking data or using a lot of database transactions.

In another embodiment of the invention, the system is designed to make partitioning the back-end database 305 very simple because that database 305 is a potential bottleneck.

Another important consideration is that parallelization tends to introduce additional complexity. In the illustrated embodiment, the process is almost transparent for the Python code involved.

Having the agents 302 do all the necessary work at fetch time works quite well up to the point when the system starts to receive large (≧1 GB) XML feeds from the sources 301. In order to avoid loading large amounts of data into memory, the harvesters 306 pre-process these data. A harvester 306 is a Python class which can download a feed file, parse it, and save the information from it to a database. It uses a schema that makes querying by the agent 302 easy. At the same time, it keeps the data in a format close to what the source 301 provides. This allows for changes to be made in the agent code without having to re-parse the feeds.

In another embodiment, many base harvester classes are written that make adding new sources easier. Examples include base harvesters for formats like Media RSS, video sitemaps, CSV, generic XML, etc.

A second very important role of the harvesters 306 is the creation of an offline cache for the data integration process. Even if the services of partners are experiencing stability issues or downtime, their data may still be available.

Once the data are received from the agents 302, the data is merged. In some situations, the quality of the data from the sources may not be very high. For example, the sources 301 may have different titles for some series. Other problems start on the series episode level. Classifying data based on episode seasons, numbers, and titles “should” be straightforward. In reality, however, simple episode classifiers that assume the authoritativeness of one source 301 prove to be limited when trying to attach data from other sources 301. Some sources 301 do not have complete information, while other sources 301 simply give incorrect information.

Another pitfall occurs when some sources 301 have bad numbers in one season and bad titles in another. What is one episode in one source 301 could be two episodes in another source 301, and it is important that the classifier can handle this sort of problem.

In another embodiment, clustering is employed to go beyond traditional classification approaches. This is particularly useful when dealing with large numbers of items (some series have thousands of episodes).

Fortunately, even if the seasons or numbers of episodes are wrong, a pretty good relative ordering of episodes from a given source can be determined. This allows the use of a dynamic algorithm inspired by the Smith-Waterman algorithm to align sequences of episodes and to use this to make clustering easier. The original Smith-Waterman algorithm is by nature limited to matching items with discrete values (the four base components of DNA) and binary similarity function (with only two results for any given items: “the same” and “different”). In implementations of the present invention, this algorithm has been modified to allow matching items with complex values and with a similarity function that calculates a distance between them. These components are referred to as matchers.

Processing movie data presents a completely different set of problems. There is a lot less information about each movie (tens of items), but ordering the information cannot be used. Another embodiment uses a special matcher for movies. It does hierarchical, agglomerative, bottom-up clustering using a custom similarity function.

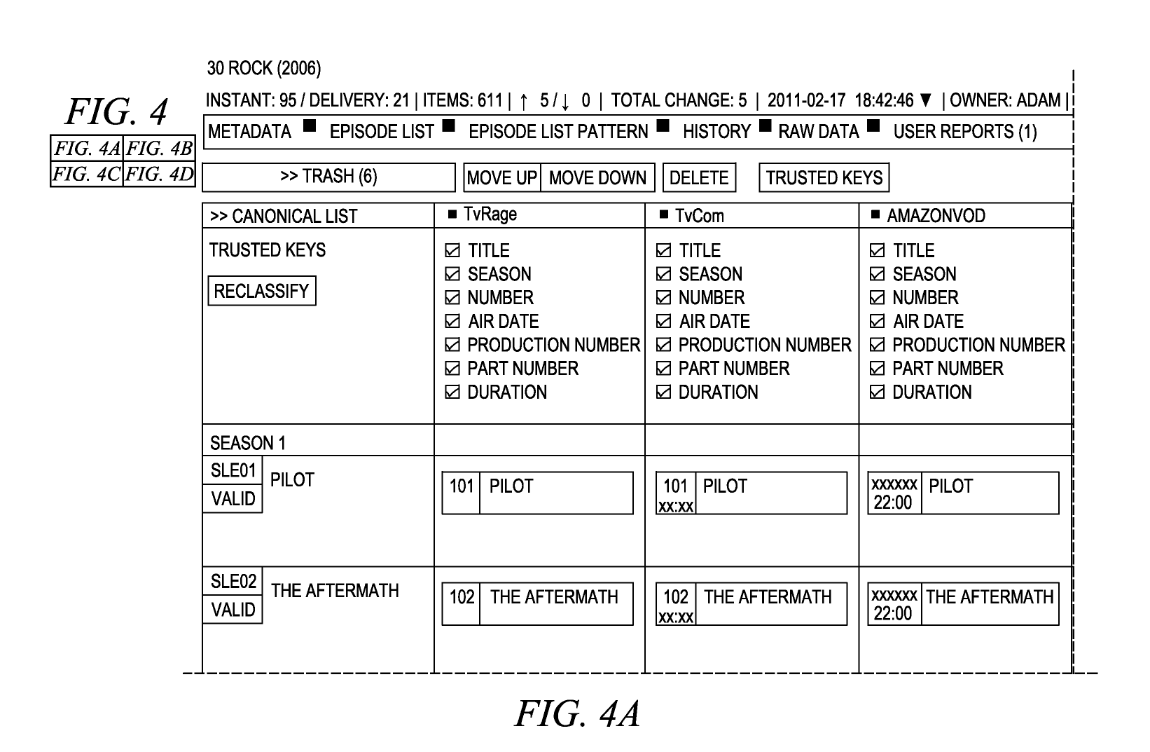

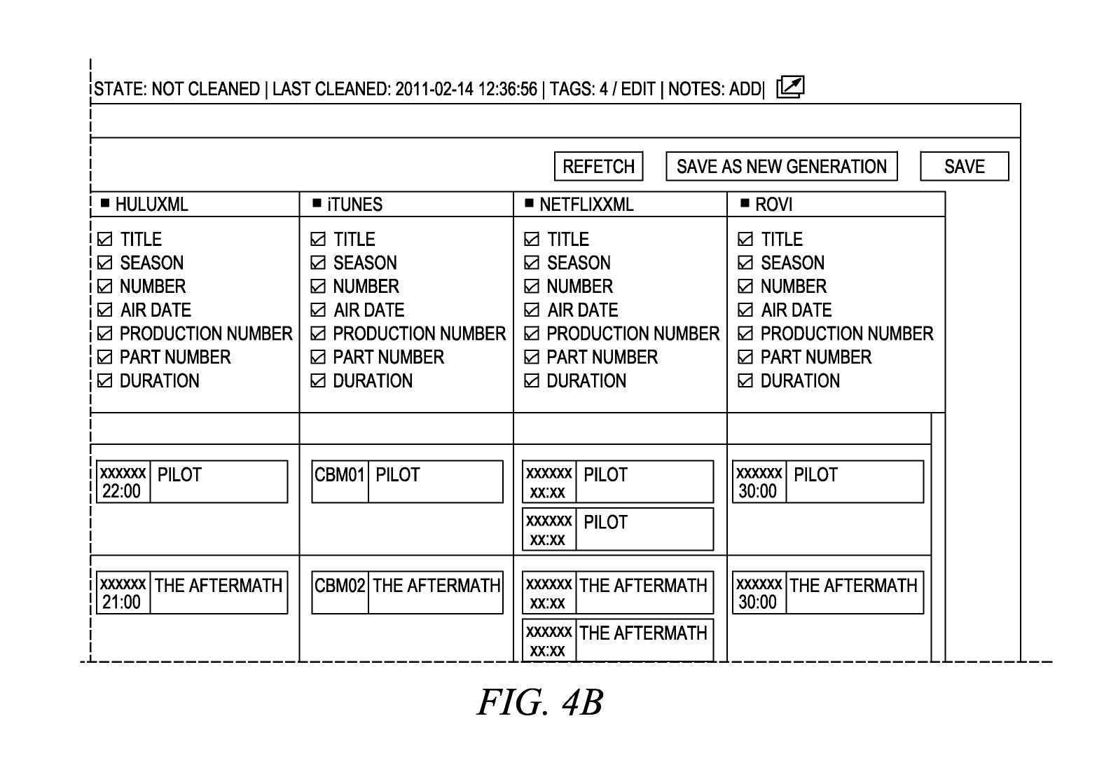

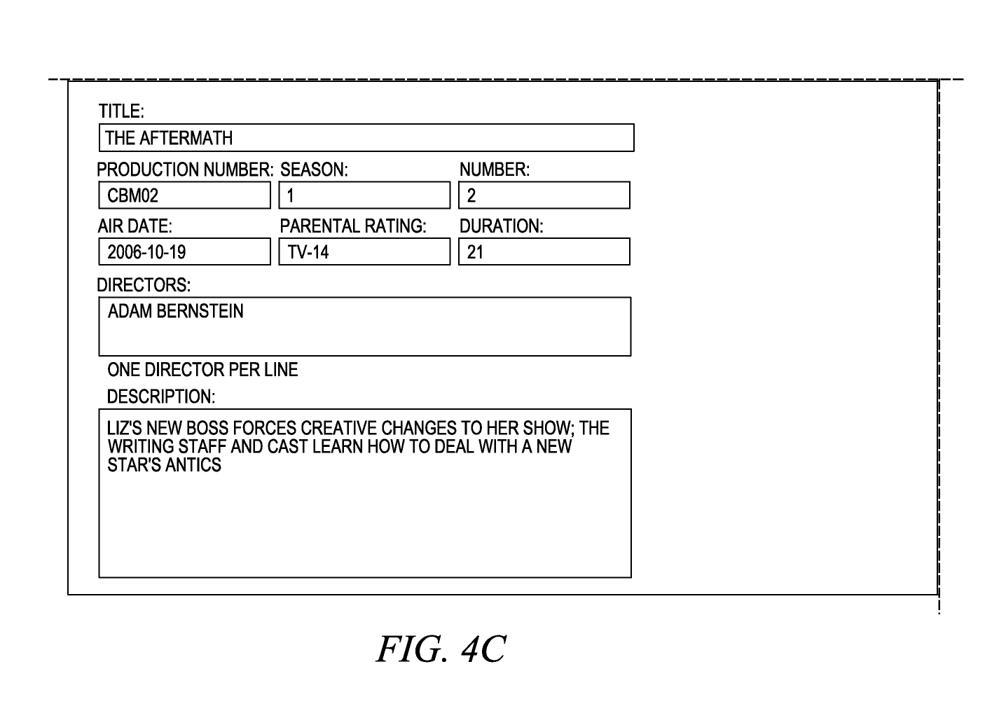

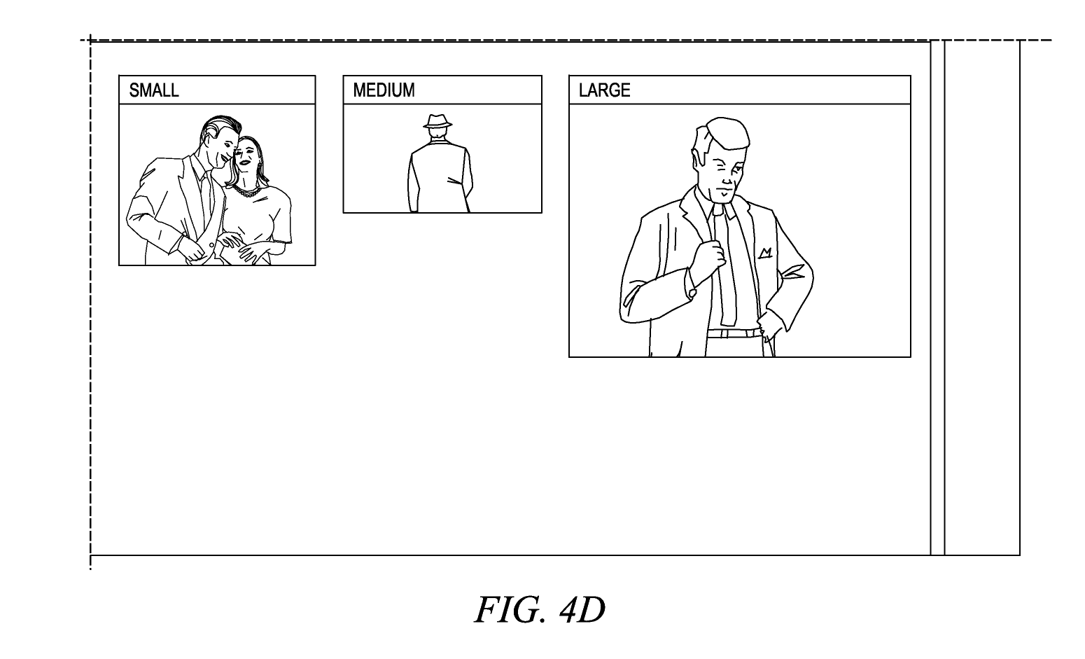

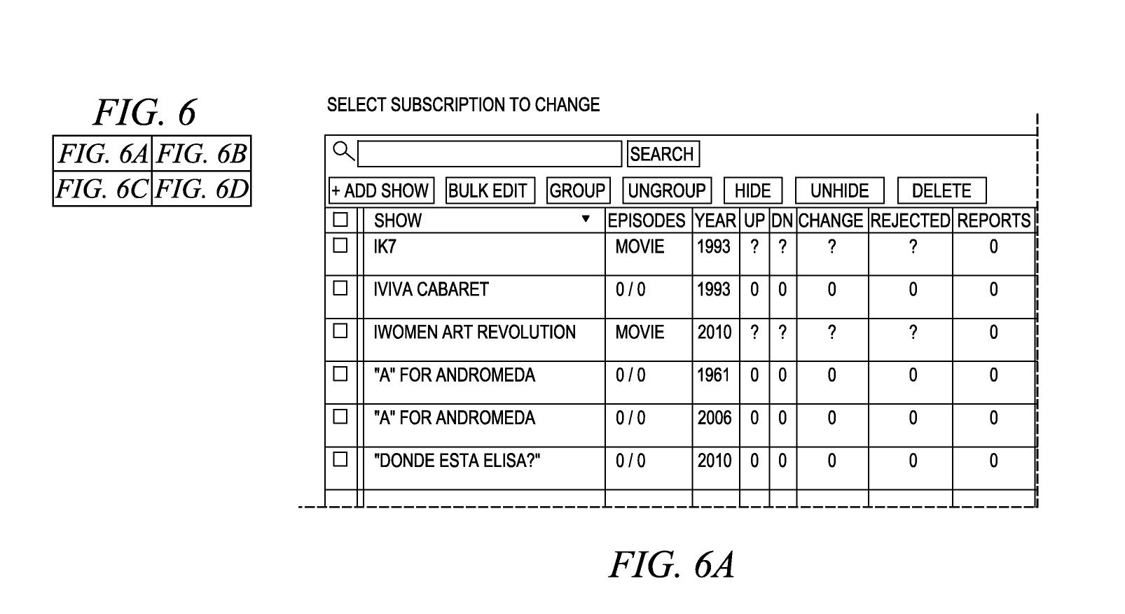

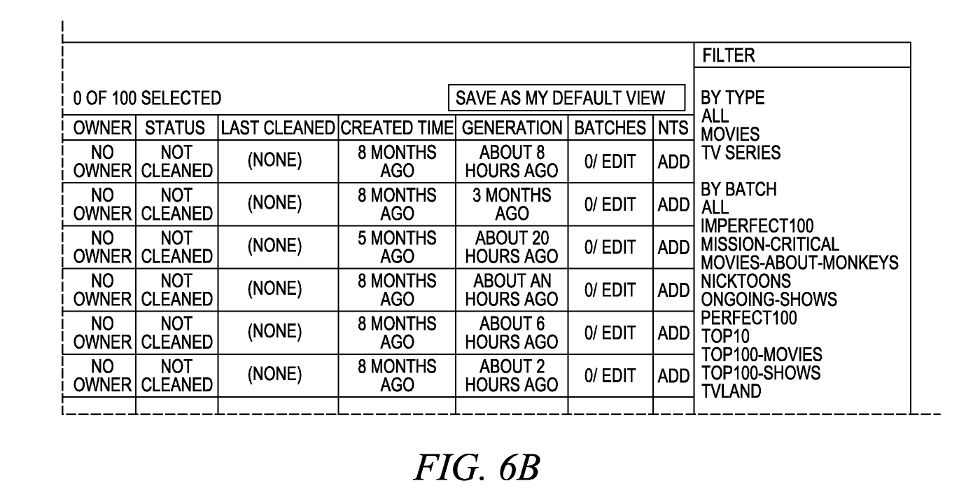

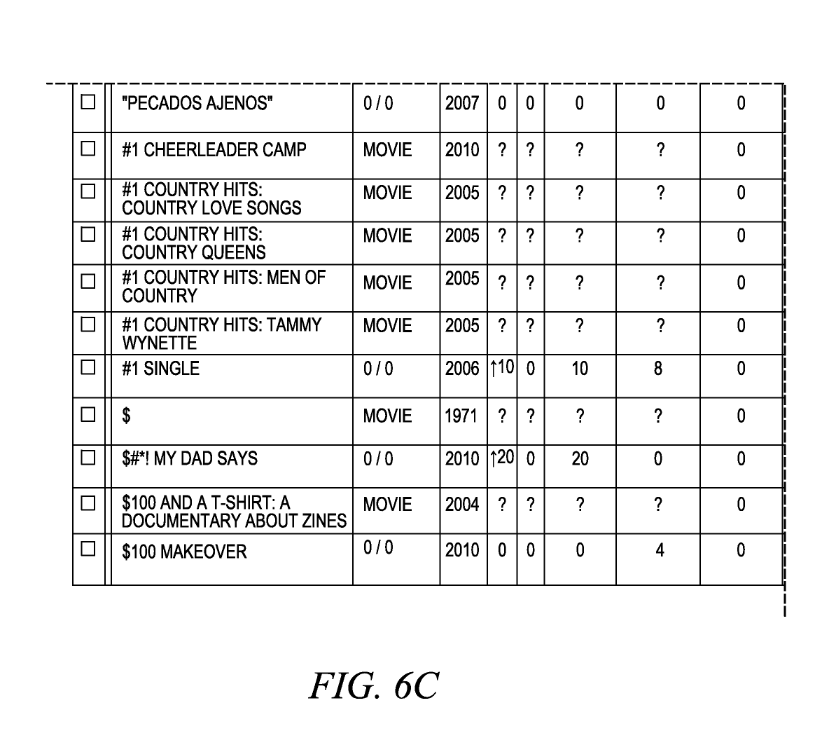

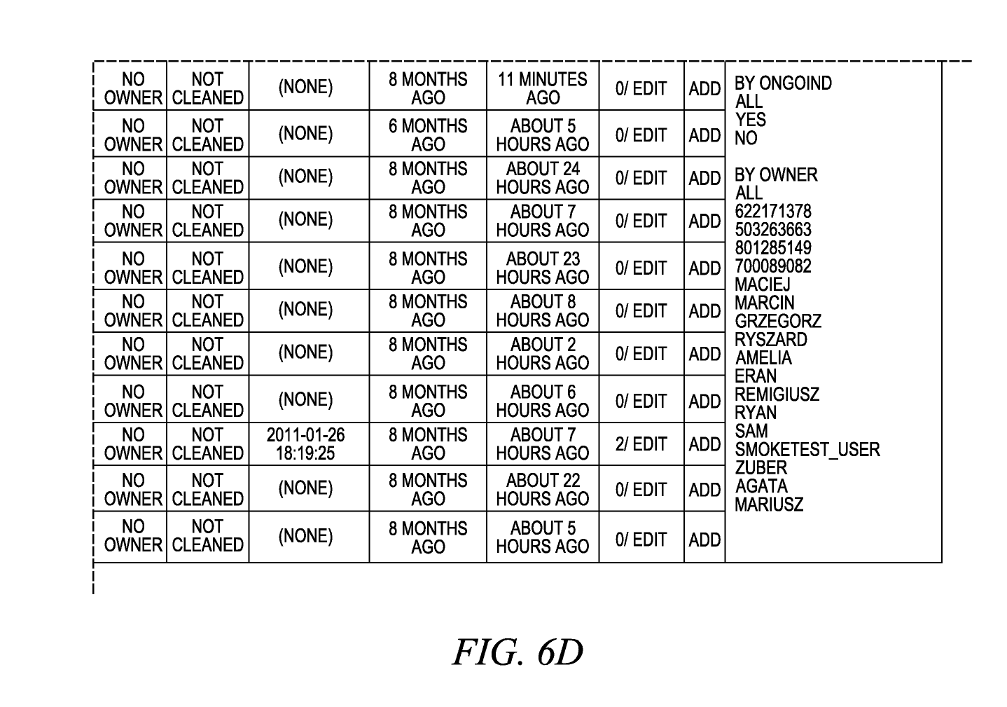

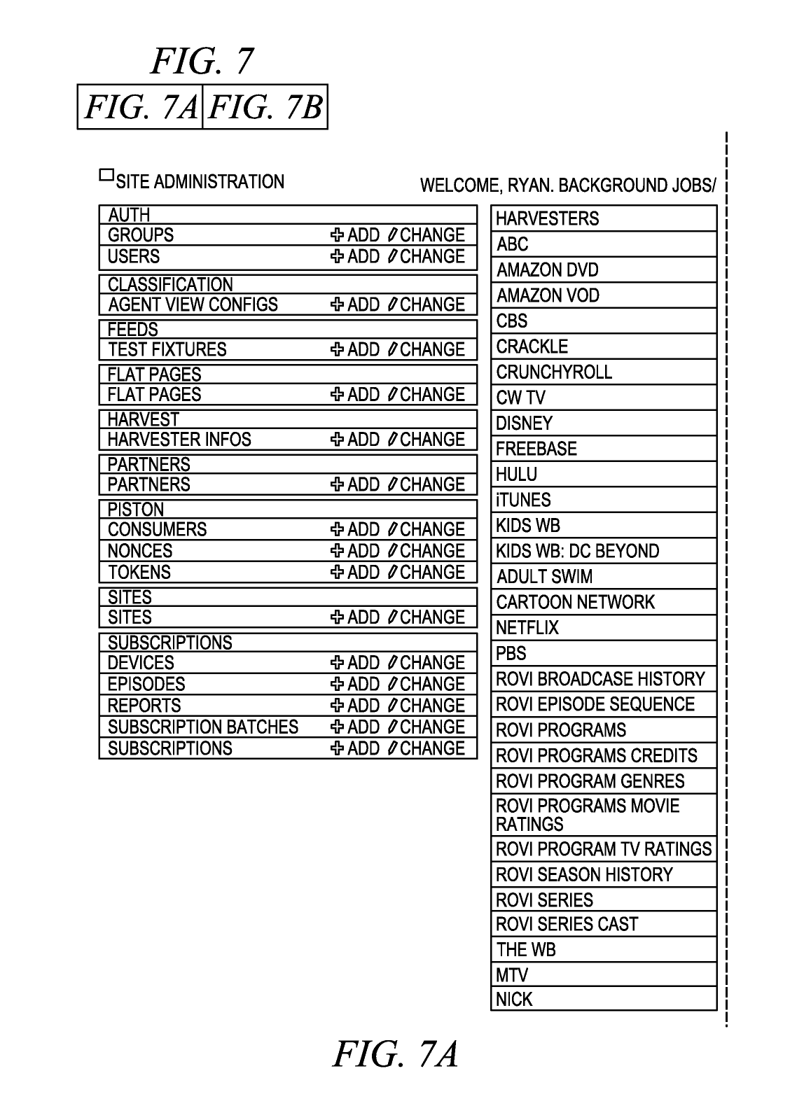

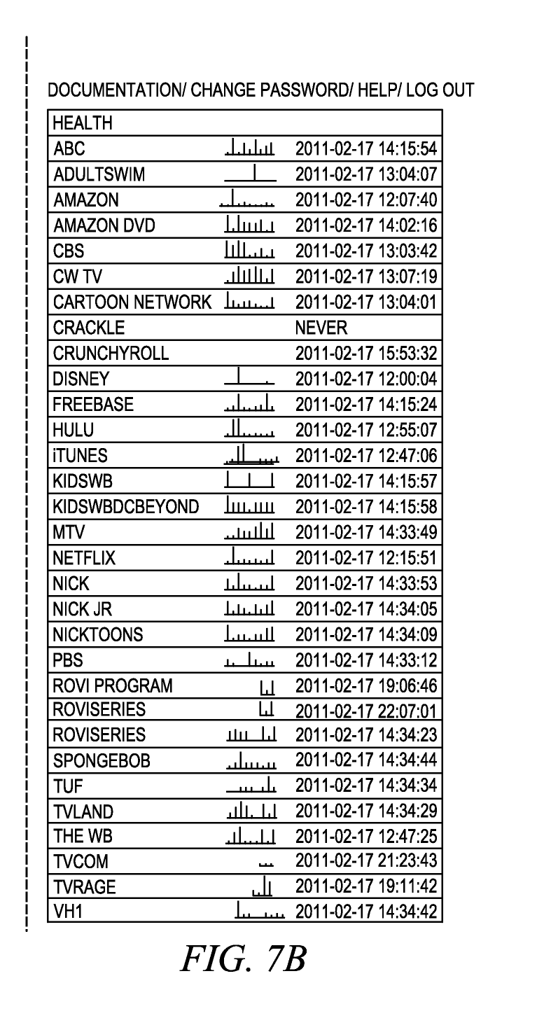

FIGS. 4 through 7 are examples of an actual user-interface that editors 308 use for manual curation. Manual curation enables human beings (as opposed to the automated machine process) to classify, cluster, and categorize data. Adding human-based editorial tools is a useful aspect of the present invention because humans may be better than the series matcher at fixing some data problems. Some of these problems approach the limit of what can be reasonably addressed in an algorithmic manner, especially as many of the problems appear only once in the whole dataset.

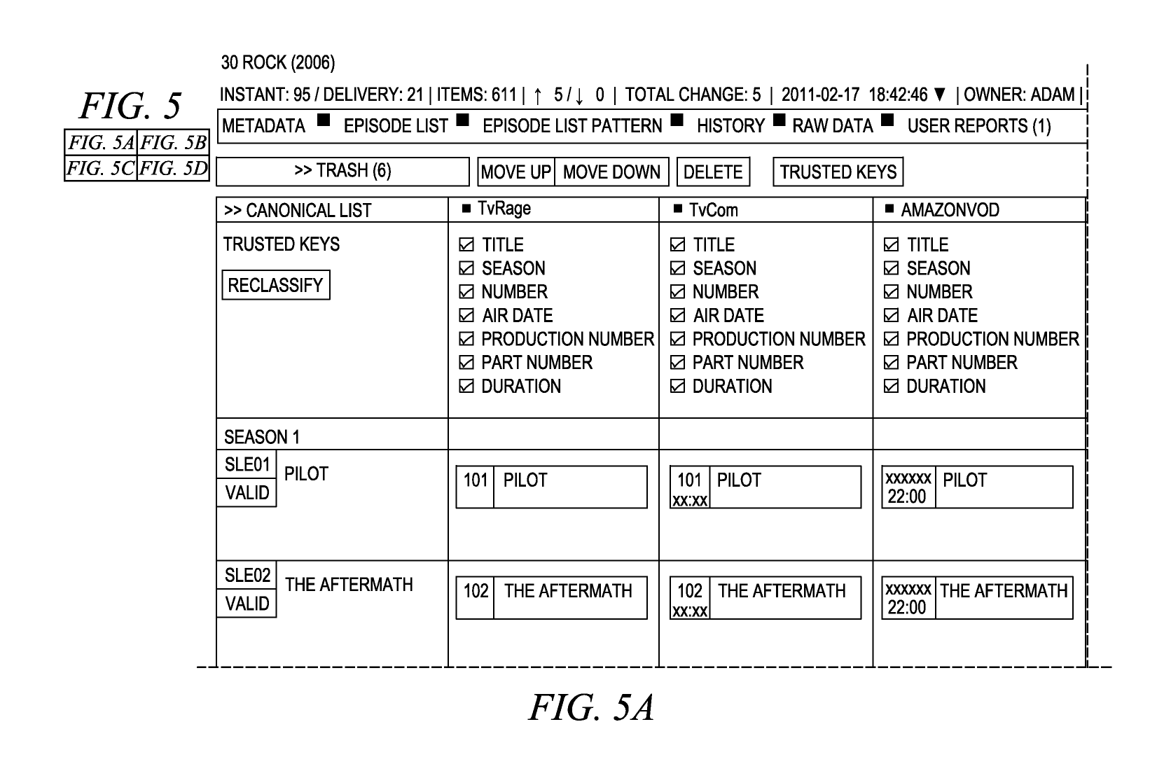

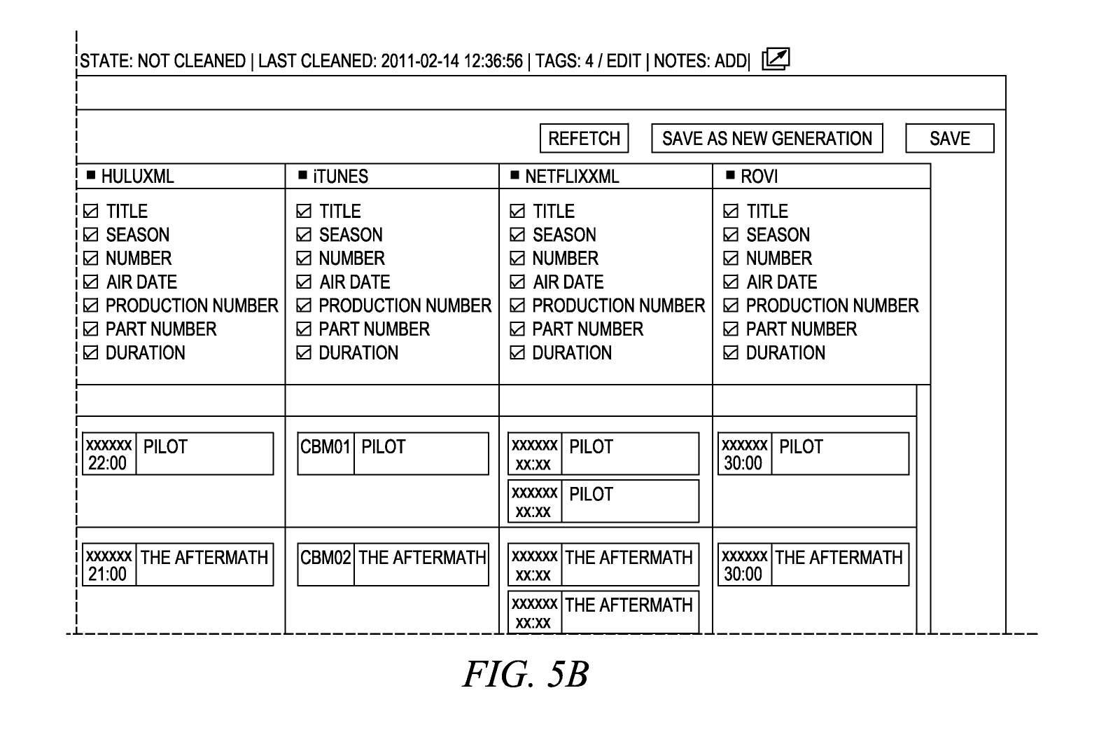

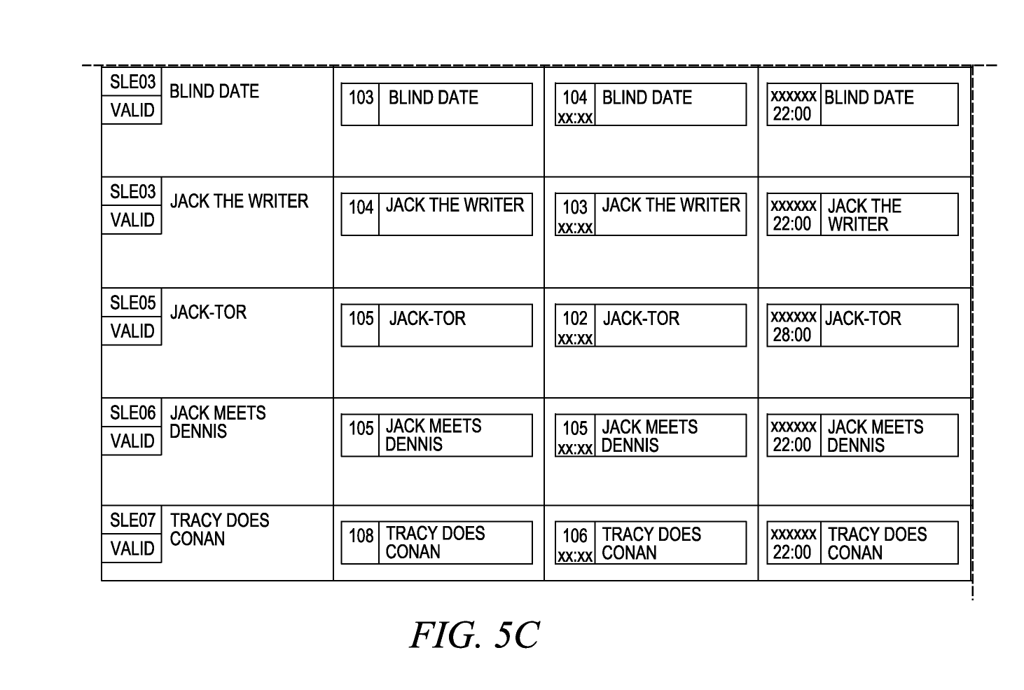

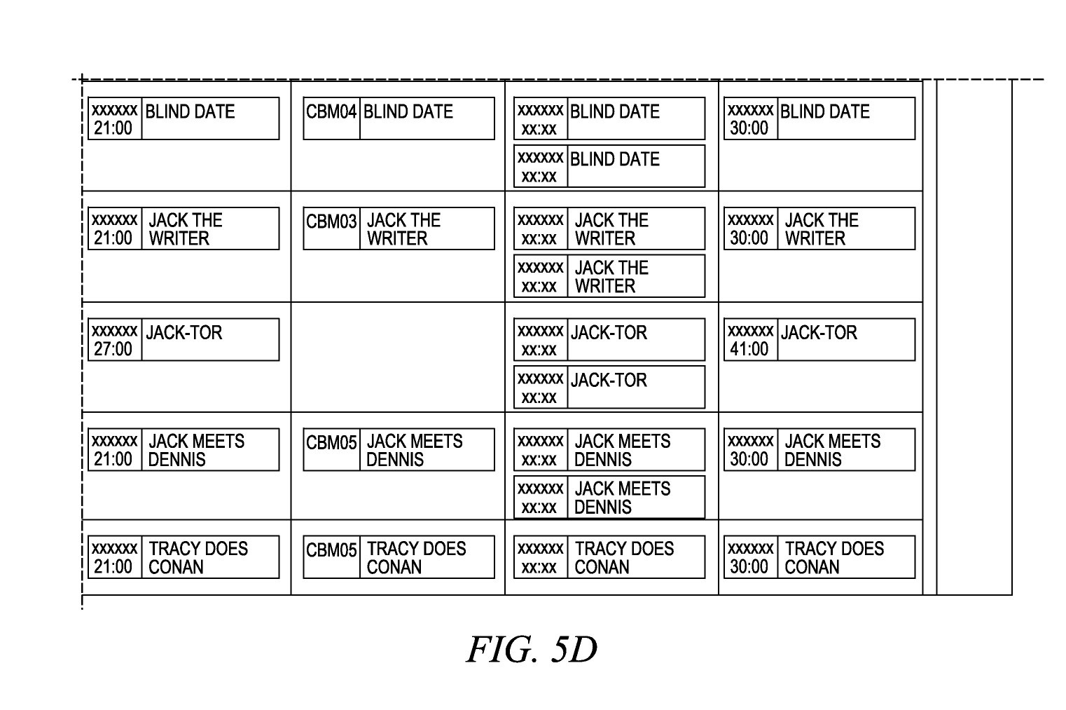

The editorial tools illustrated in FIGS. 4 through 7 are based on the Django admin panel and use jQuery to create a spreadsheet-like interface. As shown in FIG. 5, all of the metadata for a given series are displayed in a grid, with items belonging to one data cluster (which maps to an episode) grouped together. In a preferred embodiment, a user can reassign items to different clusters, move them to the trash, or edit them directly. These edits are then saved as the data pattern for the given show.

In another embodiment, a custom matcher for manually edited data is presented. The trusted keys in FIGS. 4 and 5 include descriptive classifiers such as title, season, number, air date, production number, part number, duration, and the like.

Feeding the system with manually input data can present difficulties. Even after an editor 308 has saved her edits to the data, new data from other sources continue to be collected. To address this, the adaptive pattern application 104 (see FIG. 1) integrates new data without undoing the work of the editors 308. A custom matcher for manually edited data arranges new data according to the pattern saved by the editor 308 and then separately processes data items that are completely new.

FIGS. 4 and 5 also illustrate the resultant canonical list of television or movie data provided by aspects of the present invention. Using data from at least two different sources 301, a unified list of shows and episodes across multiple sources is compiled.

The next steps include post-processing and de-normalization. The data live in two different databases: the front-end (or “slave”) 304 and the back-end (or “master”) 305. Different parts of the system need access to different parts of the data with different access patterns, so splitting and mirroring them in the right way improves performance. A number of historical copies of the data are kept in case the quality of a source 301 deteriorates. Data is kept in big blobs of JSON text, opaque to the database. This blob also contains information about any edits by users. The table contains a few additional columns that are needed for querying. In the front-end 304, only the newest copy of the data is needed. The data should allow easy and flexible querying. Data are kept as separate database tables, connected through foreign key relations. Data for auto-completion, etc., are also kept separately.”

In an embodiment, the API is RESTful and JSON based. It works well with JavaScript. It can also embed client affiliate codes into the links.

The feed 307 (see FIG. 3) is designed to be lightweight, easy to parse, and easy to import into a relational database. Formats for the feed 307 can include XML, a TMS feed format, and a CSV based format.

The back-end 305 processing can be very resource intensive. However, this should not affect the performance of the client facing front: the API and the feed generators. In some embodiments, the back-end 305 and the front-end 304 are served by two separate MySQL databases, living on different EC2 instances. The front-end 304 database receives data updates through MySQL replication.

This same multi-machine parallel approach used to process all metadata of TVs and movies can also be applied to entertainment data including all forms of music and literature.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method comprising:
collecting, by a computer processing system, entertainment metadata from at least one source in an original format;
identifying, by the computer processing system, constituent elements of the entertainment metadata; and
mapping, by the computer processing system, the constituent elements to a single means of identification.

2. The method of claim 1 wherein the constituent elements of the entertainment metadata comprise an element selected from the group consisting of: images, descriptions, air date, Internet links, duration, production number, and season.

3. The method of claim 1 wherein mapping the constituent elements to a single means of identification comprises using a clustering method which does not subtract information.

4. A method comprising:
displaying, by a computer processing system on a graphical display, constituent metadata elements from at least one source;
enabling, by the computer processing system, an ability to drag elements from a source into a proper category as defined by another source; and
enabling, by the computer processing system, an ability to set which entertainment metadata elements from individual metadata sources should be trusted or distrusted.

5. The method of claim 4 wherein the graphical display is in a grid-like format.

6. The method of claim 4 wherein the ability to set which entertainment metadata elements from individual metadata sources should be trusted or distrusted employs an algorithmic process.

7. A method comprising:
incorporating, by a computer processing system, algorithmic and manually curated data into a single dataset;
learning, by algorithmic processes running on the computer processing system, better pattern recognition from implicit actions of a manual curation process; and
learning, by the algorithmic processes, better pattern recognition from explicit actions of a manual curation process.

8. A system for use with at least a first media source and a second media source, each media source being located on a local area network, wherein at least one of the first and second media sources provide data indicating available media content found on the local area network and stored in an original format on or accessible by at least one of the first media source and the second media source, the system comprising:
a playback device located on the local area network and in electronic communication with at least one of the first media source and the second media source, wherein the playback device includes an input system for receiving data indicating available media content at a client device;
a display device for displaying information identifying at least a portion of the available media content; and
a processor system for pulling at least some portion of the available media content to the client device for subsequent playback in the original format.
